(19) United States
(12) Patent Application Publication
(10) Pub. No.: US 2026/0337085 A1
(43) Pub. Date: Oct. 29, 2026

(54) NIP ROLLER SYSTEM FOR GLASS RIBBON

(71) Applicant: CORNING INCORPORATED, CORNING, NY (US)

(72) Inventors: BENJAMIN LOGAN CARL, CORNING, NY (US); DAVID POSADA-PINEDA, ELMIRA, NY (US); PAUL SCHERER, LEXINGTON, KY (US)

(21) Appl. No.: 19/116,033

(22) PCT Filed: Sep. 19, 2023
(86) PCT No.: PCT/US2023/033112

§ 371 Date: Mar. 27, 2025

Related U.S. Application Data
(60) Provisional application No. 63/411,264, filed on Sep. 29, 2022.

(51) Int. Cl. C03B 35/16; B65G 49/06; C03B 33/03

(52) U.S. Cl. CPC C03B 35/163; B65G 49/064; C03B 35/162; C03B 33/03

(57) ABSTRACT

A nip roller system includes a nip roller configured to contact a glass ribbon and apply an adjustable downward force to the glass ribbon as the glass ribbon travels between the nip roller and an opposing roller of a glass ribbon conveying system, wherein a 6 o'clock position of the nip roller is aligned with a 12 o'clock position of the opposing roller.

### CROSS-REFERENCE TO RELATED APPLICATION

This application claims the benefit of priority under 35 U.S.C. § 119 of U.S. Provisional Application Ser. No. 63/411264 filed on Sep. 29, 2022, the content of which is relied upon and incorporated herein by reference in its entirety.

### FIELD OF INVENTION

The present disclosure relates to a nip roller system. More specifically, the present disclosure relates to an adjustable pressure regulated nip roller system that more accurately controls glass ribbon conveyance, stabilizes the score and separate process, and minimizes glass ribbon breakage in the backup breakage system (BBS) during glass production.

In a glass forming process a ribbon of glass is conveyed on a series of driven rollers from a viscous turn machine through a lehr or controlled cooling apparatus (CCA) and ends at a score and separate and BBS equipment, where the glass ribbon is separated into individual sheets. Instability in the glass ribbon conveyance, score and separate, and BBS have been observed at ribbon thicknesses below 0.8 mm due the lower mass of the glass ribbon slipping on the conveying rollers. Thinner glass ribbons, for example, in a thickness range of about 0.5 mm-1.0 mm are lighter compared to thicker glass ribbons. As a result, the lighter weight glass ribbons provide less contact and friction on the conveying roller system. Therefore, portions of lighter glass ribbons can slip, lift off, or move side-to-side on the conveying roller system. This situation can cause the glass ribbon downstream to back-up interrupting the continuous ribbon forming process.

Additionally, the glass ribbon needs to be in a predetermined position on the conveying system so that the process of scoring and separating individual glass sheets from the glass ribbon is repeatable without breakage. Also, the scoring action can move a lighter glass ribbon while traversing the glass ribbon causing unwanted instability. Bending and instability of the glass ribbon during scoring and separation can cause a wave to propagate upstream causing an unsafe disturbance in glass ribbon. These instabilities create a need for a tension roller mechanism to apply a downward force on the glass ribbon to increase pressure, improve conveyance, and stabilize the glass ribbon while glass sheets are being produced from the glass ribbon.

### SUMMARY

The present disclosure relates to a tension roller mechanism or nip roller system that improves conveyance of thin glass ribbons and stabilizes the glass ribbons while glass sheets are being produced from the glass ribbon. The nip roller system is fully adjustable and applies a downward force on the glass ribbon to increase pressure from the glass ribbon to the conveying roller system to more accurately control conveyance of the glass ribbon and stabilize the glass ribbon during the process of scoring and separating glass sheets from the glass ribbon and when the BBS is in operation.

According to an embodiment of the present disclosure, a nip roller system includes a nip roller configured to contact a glass ribbon and apply an adjustable downward force to the glass ribbon as the glass ribbon travels between the nip roller and an opposing roller of a glass ribbon conveying system, wherein a 6 o'clock position of the nip roller is aligned with a 12 o'clock position of the opposing roller. The nip roller system can further include an across-ribbon adjustment mechanism configured to move the nip roller in a direction perpendicular to a direction in which the glass ribbon travels while the nip roller is in contact with a traveling glass ribbon.

In an aspect, the across-ribbon adjustment mechanism is mounted to a member positioned over the glass ribbon conveying system, and the across-ribbon adjustment mechanism comprises a liner motion control device.

In an aspect, the liner motion control device comprises a slide.

In an aspect, the across-ribbon adjustment mechanism includes a liner motion control device; and an extension rod comprising a first end connected to the liner motion control device and a second end connected to a handle.

The nip roller system can further include a support structure securing the nip roller and the across-ribbon adjustment mechanism above the glass ribbon conveying system.

The nip roller system can further include an upstream-downstream adjustment mechanism configured to move the nip roller in a direction parallel to a direction in which the glass ribbon travels.

In an aspect, the upstream-downstream adjustment mechanism includes a member extending across the glass ribbon conveying system and connected to the nip roller, and a plurality of interconnecting brackets securing the member with respect to the glass ribbon conveying system.

The nip roller system can further include an across-ribbon adjustment mechanism comprising a member extending across the glass ribbon conveying system and including a slot; and a mounting plate to which the nip roller is connected, the mounting plate moveable in the slot.

The nip roller system can further include an air cylinder assembly configured to move the nip roller in a vertical direction.

In an aspect, the air cylinder assembly includes an air cylinder comprising a piston that extends or retracts based on a pressure of an air source in fluid communication therewith to move the nip roller; and a water cooled plate adjacent to the air cylinder to cool the air cylinder.

The nip roller system can further include a nip roller assembly comprising a frame comprising an axle providing a rotational axis about which the nip roller rotates; a roll pivot; and a yaw pivot.

In an aspect, the nip roller is configured to contact a central portion of the glass ribbon.

According to another embodiment of the present disclosure, a glass ribbon conveying system includes a drive roller configured to move the glass ribbon; a nip roller configured to contact the glass ribbon and apply an adjustable downward force to the glass ribbon as the glass ribbon travels between the nip roller and the drive roller; and an adjustment mechanism configured to move the nip roller in a direction lateral to which the glass ribbon travels while the nip roller is in contact with the glass ribbon.

In an aspect, the adjustable downward force is provided by an air cylinder.

In an aspect, the adjustment mechanism a liner motion control device; and an extension rod comprising a first end connected to the liner motion control device and a second end connected to a member configured to rotate the extension rod.

According to another embodiment of the present disclosure, a method of conveying a glass ribbon includes driving the glass ribbon with a drive roller; and applying an adjustable downward force to the glass ribbon by a nip roller as the glass ribbon travels between the drive roller and the nip roller, wherein a 6 o'clock position of the nip roller is aligned with a 12 o'clock position of the drive roller.

The method can further include adjusting a position of the nip roller in a direction perpendicular to that in which the glass ribbon travels while the nip roller is in contact with the glass ribbon.

The method can further include adjusting the downward force by changing an air pressure supplied to an air cylinder that comprises a piston that extends or retracts based on the air pressure to move the nip roller.

In an aspect, the adjusting the position of the nip roller is performed by rotating an extension rod of a liner motion control device connected to the nip roller.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 is a perspective view of a nip roller system positioned over a portion of glass ribbon conveying system.

FIG. 2 is a perspective view of an embodiment of the nip roller system according to the present disclosure.

FIG. 3 is a perspective view of the nip roller system from an opposing direction as the view of FIG. 2.

FIG. 4 is a perspective view of an upstream-downstream adjustment mechanism.

FIG. 5 is a perspective view of a coarse across-ribbon adjustment mechanism.

FIG. 6 is a perspective view of a fine across-ribbon adjustment mechanism.

FIG. 7 is a perspective view of an air cylinder assembly.

FIG. 8 is a rear perspective view of the air cylinder assembly.

FIG. 9 is a perspective view of a nip roller assembly.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

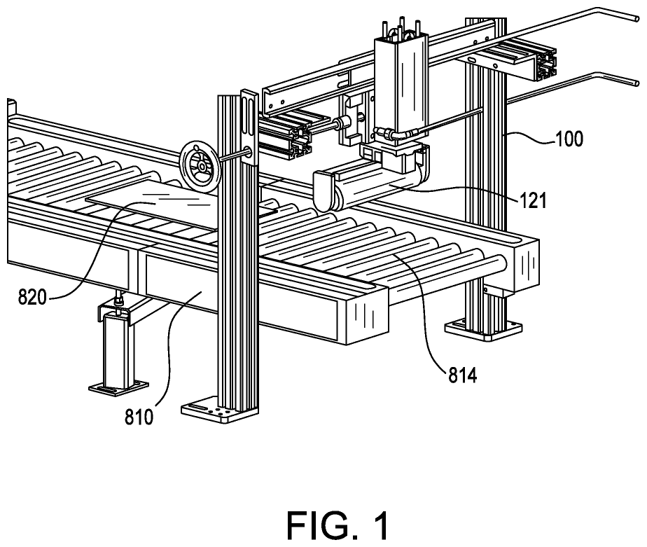

This disclosure describes a pressure regulated tension (nip) roller system 100 that can apply an adjustable downward force on a glass ribbon 820, for example, while opposing a driven roller 814 of a glass ribbon conveying system 810 to improve conveyance of the glass ribbon 820. As shown in FIG. 1, the nip roller system 100 can be located on a lehr frame and positioned over a portion of the glass ribbon conveying system 810 such that a nip roller 121 is directly above a conveying roller 814, preferably a drive roller, of the glass ribbon conveying system 810. A portion of the glass ribbon 820 (traveling from right to left) has been removed from FIG. 1 to expose the conveying rollers. The nip roller 121 can be oriented such that the 6 o'clock position of the nip roller 121 is aligned with the 12 o'clock position of the drive roller. Roller alignment of 12 o'clock and 6 o'clock is critical to prevent breakage of the glass ribbon. If the rollers are misaligned, and the nip roller 121 applies pressure away from the tangent point of the drive roller, there is potential for the glass ribbon to break because the glass ribbon is unsupported at that location.

A glass scoring system can be located downstream of the nip roller system 100 and include a laser, a water jet, a scribe, or a wheel with diamond points, tips, teeth, or edges. The nip roller system 100 can be mounted in an assembly with adjustability in the vertical and lateral directions (yaw and roll) to prevent unwanted veering of the glass ribbon 820 as it travels down the glass ribbon conveying system 810.

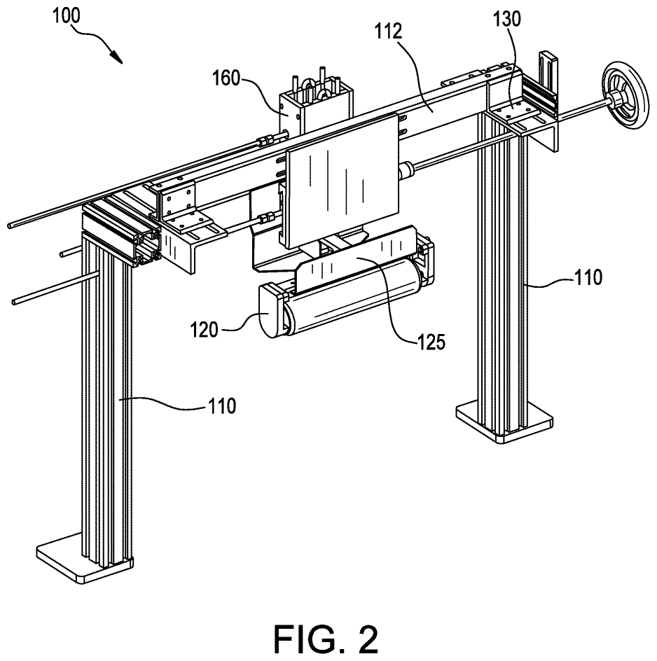

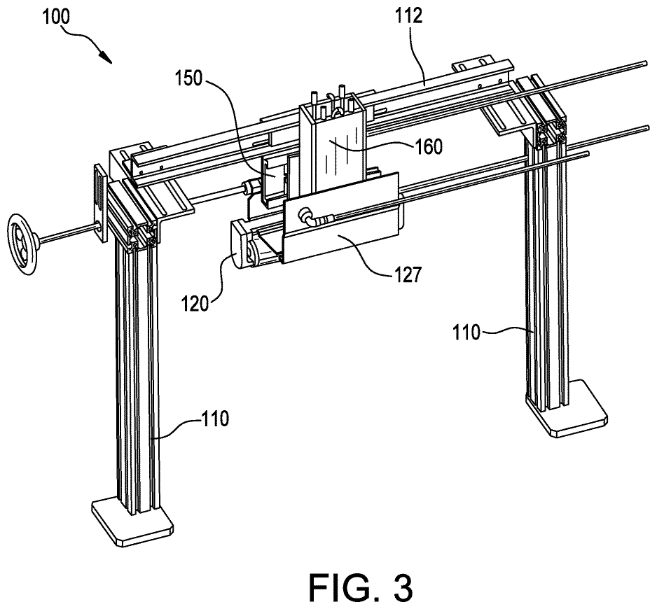

FIG. 2 is a perspective view of the nip roller system 100 according to the present disclosure. FIG. 3 is a perspective view of the nip roller system 100 from an opposing direction as the view of FIG. 2. As shown, the nip roller system 100 can include a support structure that supports a nip roller 120 assembly and adjustment mechanisms above the glass ribbon conveying system 810 shown in FIG. 1. For example, the support structure can include two vertical legs 110 connected at the top by a cross brace or member 112. The two vertical legs 110 can be secured at the bottom to a portion of the lehr frame, a mounting plate, a floor, or any other suitable base support with one on each side of the glass ribbon conveying system 810. In other examples, the support system can have any other structure suitable to securely support the nip roller assembly 120 and adjustment mechanisms such as an A-frame, C-arm, and the like. The nip roller assembly 120 and portions of the adjustment mechanisms can be attached to the cross member 112.

The nip roller system 100 can also include the nip roller assembly 120, an upstream-downstream adjustment mechanism 130, a coarse across-ribbon adjustment mechanism 140, a fine across-ribbon adjustment mechanism 150, and an air cylinder assembly 160. The nip roller assembly 120 can include heat shields 125 and 127 to shield heat from components of the nip roller assembly 120, the fine across-ribbon adjustment mechanism 150, and the air cylinder assembly 160.

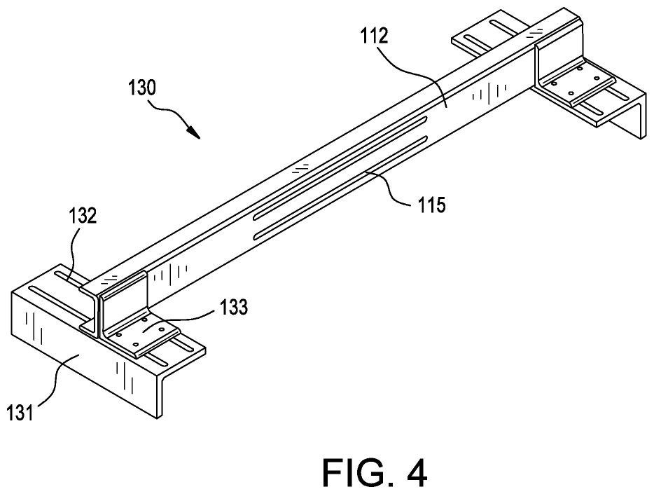

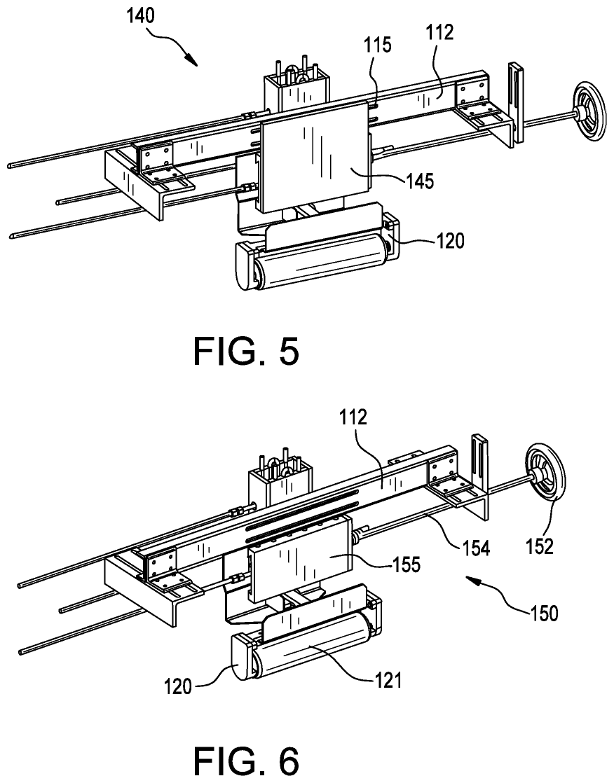

As shown in FIG. 4, the cross member 112 can be included as a portion of the coarse upstream-downstream adjustment mechanism 130 used for initial alignment of the nip roller assembly 120 with respect to the glass ribbon conveying system 810. The upstream-downstream adjustment mechanism 130 can include the cross member 112 and a plurality of interconnecting L-brackets that connect ends of the cross member 112 to the vertical legs 110, as shown in FIGS. 2 and 3. For example, first L-brackets 131, one on each side, can be attached to a corresponding vertical leg 110 and include a slot or slots 132 extending in a direction substantially parallel to a direction in which the glass ribbon 820 travels. Second L-brackets 133, one on each side, can be respectively attached to the first L-brackets 131 and the cross member 112. The second L-brackets 133 can be attached to the first L-brackets 131 using fasteners through holes in the second L-brackets 132 and the slots 132 of the first L-brackets 131. As such, the positioning of the second L-brackets 132 and the cross member 112 can be easily moved in a direction parallel to that in which the glass ribbon 820 travels within the limits of the slots 132. Because the nip roller assembly 120 is secured to the cross member 112, repositioning the cross member 112 also repositions the nip roller assembly 120 with respect to the vertical legs 110 and the glass ribbon conveying system 810. Once in position, the cross member 112 and other connecting components can be locked into place by tightening the fasteners through the second L-brackets 132 and the slots 132 of the first L-brackets 131. FIG. 4 also shows that the cross member 112 can include slots 115 used for lateral alignment of the nip roller assembly 120 discussed with respect to FIG. 5.

FIG. 5 shows that the cross member 112 can also be included as a portion of a coarse across-ribbon adjustment mechanism 140 used for initial lateral alignment of the nip roller assembly 120. As a portion of the coarse across-ribbon adjustment mechanism 140, the cross member 112 can include the slots 115 that can be located in a central portion of the cross member 112 and extend in a direction substantially perpendicular to the direction in which the glass ribbon 820 travels. A mounting plate 145 to which the nip roller assembly 120 is attached can be attached to the cross member 112 using fasteners through holes in the mounting plate 145 and the slots 115 of the cross brace 112. As such, the positioning of the mounting plate 140 can be easily moved in a direction perpendicular to that in which the glass ribbon 820 travels within the limits of the slots 115 in the cross member 112. Because the nip roller assembly 120 is secured to the mounting plate 145, repositioning the mounting plate 145 also repositions the nip roller assembly 120 side-to-side with respect to the vertical legs 110 and the glass ribbon conveying system 810.

FIG. 6 shows that the nip roller system 100 can also include the fine across-ribbon adjustment mechanism 150 used to fine tune the lateral relationship of the nip roller system 100 to the moving glass ribbon in smaller increments than that provided by the coarse across-ribbon adjustment mechanism 140. The fine across-ribbon adjustment mechanism 150 is configured to move the nip roller assembly 120 side-to-side with respect to the vertical legs 110 and the glass ribbon conveying system 810 in real time or “on the fly” even while the nip roller 121 is in contact with the moving glass ribbon 820. The nip roller assembly 120 can be secured to the fine across-ribbon adjustment mechanism 150. The fine across-ribbon adjustment mechanism 150 can be secured to the cross member 112 via the mounting plate 145 (removed from FIG. 6 for clarity) and used to fine tune the positioning of the nip roller assembly 120 to more precisely control the glass ribbon conveyance. A hand wheel handle 152 or crank can be connected to one end of an extension rod 154 that is connected at the other end to a linear motion control device 155 such as a linear bearing or dovetail slide, for example. The linear motion control device 155 can be driven by a ball or a lead screw for fine positioning.

The hand wheel handle 152 can be manually rotated by an operator. An operator that is monitoring the glass forming process can rotate the hand wheel handle 152 to finely adjust the lateral position of the nip roller assembly 120. Optionally, adjustment of the fine across-ribbon adjustment mechanism 150 can be powered. For example, adjustment of the linear motion device 155 can be driven by a motor. A sensor system such as an imaging system, for example, can be used to monitor the glass ribbon conveyance. An operator monitoring the sensor system and the glass ribbon conveyance from a remote location can remotely control a motor to adjust the lateral position of the nip roller assembly 120. Optionally, adjustment of the lateral position of the nip roller assembly 120 via the fine across-ribbon adjustment mechanism 150 can be automated and controlled by a computer.

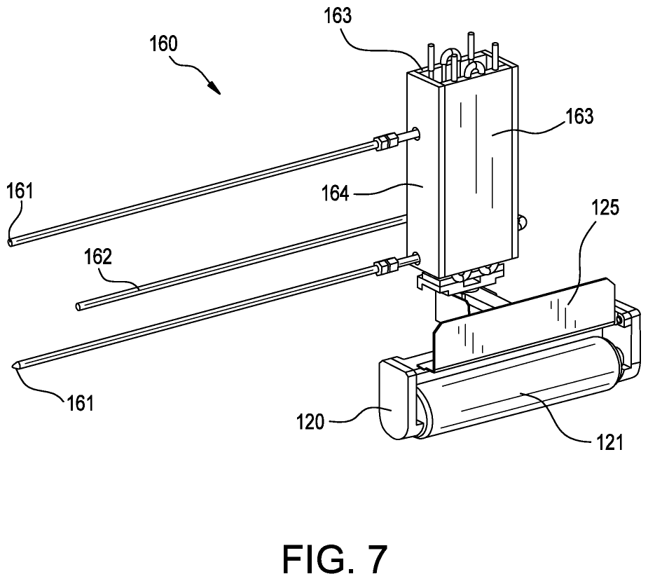

The nip roller system 100 can also include the air cylinder assembly 160 with a pressure regulated air supply to allow for adjustment to the force applied to the glass ribbon 820 by the nip roller 121, as shown in FIG. 7. The force applied is determined by the pressure supplied to an air cylinder as part of the air cylinder assembly 160. The force is also determined by the weight of the nip roll assembly 100. The pressure in the air cylinder can be adjusted to shift a portion or the totality of the nip roll assembly weight away from the glass ribbon. Excessive force on the glass ribbon can result in breakage.

The air cylinder assembly 160 includes the air cylinder acting as a pneumatic actuator that converts compressed air energy into linear motion. Here, pneumatic pressure acts on a piston inside a cylinder to extend or retract the piston. The air cylinder assembly 160 can be mounted to the fine across-ribbon adjustment mechanism 150 for side-to-side positioning. As shown in FIG. 7, the nip roller assembly 120 can be mounted to the air cylinder assembly 160. The air cylinder allows for the nip roller assembly 120 to be retracted during process start-up and in upset conditions.

FIG. 7 shows that the air cylinder assembly 160 can include air supply lines 161 to supply compressed air to the air cylinder. The air cylinder assembly 160 can also include an air cooling line 162 for cooling the air cylinder and water cooled plates 163 and a protective housing 164 to protect the air cylinder. The air supplied via the air supply lines 161 is used to cycle the air cylinder up and down. The air is pressure regulated to control the nip force to the glass ribbon. The air suppled via the air cooling line 162 blows on the rods of the air cylinder, keeping them within the operating temperature to prevent failure of the air cylinder. The water supplied via the water cooled plates 163 mounted to the body of the air cylinder assembly 160 keeps the air cylinder assembly 160 within operating temperature and preventing failure.

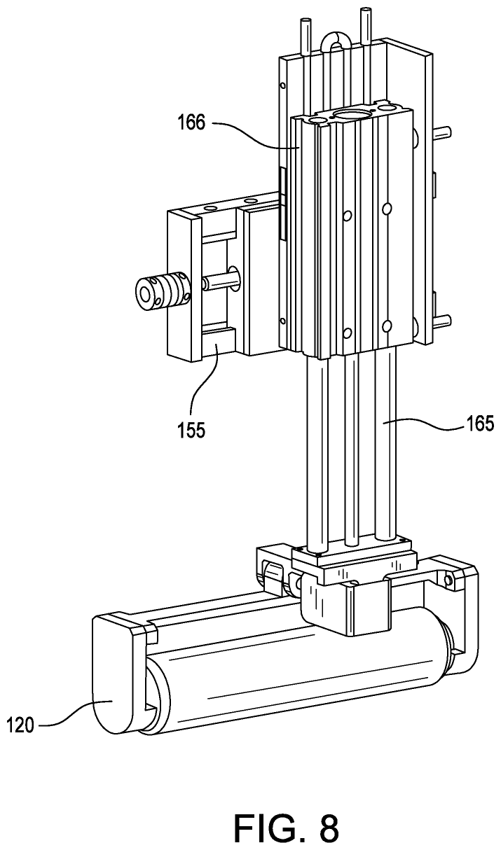

FIG. 8 is a rear view of portions of the air cylinder assembly 160 with pistons 165 of the air cylinder 166 extended. One of the water cooled plates 163 and a side of the protective housing 164 have been removed in the view to show the air cylinder 166. This view also includes the linear motion control device 155.

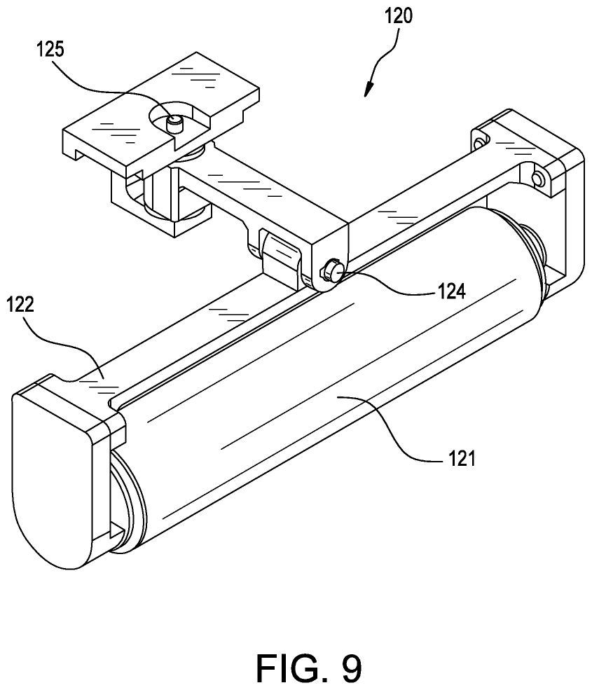

FIG. 9 is a perspective view of the nip roller assembly 120. The nip roller assembly 120 can include a frame 122 with an axle or bearing providing a rotational axis in which the nip roller 121 rotates. The nip roller 121 can be any suitable length and material depending on the application. For example, the nip roller 121 can be about a 4-inch-wide fused silica roller. The glass ribbon 810 can be fully formed at the point where the nip roller system 120 is installed. Therefore, a suitably sized nip roller 121 can be used to ensure a proper force is applied at the flattest area of the glass ribbon 810 to avoid damage to the glass ribbon. Optionally, the nip roller 121 can include circumferential grooves so that only portions of the nip roller 121 contact the glass ribbon. Optionally, the nip roller assembly 120 can include multiple nip rollers arranged next to each other and having the same rotational axis.

The frame 122 can also include features to attach a roll pivot 124 and a yaw pivot 125. For example, the roll pivot 124 can be shape mounted through a pair of high temperature bushings and the yaw pivot can be a shoulder bolt mounted through a pair of high temperature ball bearings. These pivots provide the nip roller 121 the self-aligning capability and are not locked in place. The nip roller assembly 120 moves freely, allowing it to track to the position of the glass ribbon without moving or impacting the glass ribbon position.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A nip roller system comprising:
a nip roller configured to contact a glass ribbon and apply an adjustable downward force to the glass ribbon as the glass ribbon travels between the nip roller and an opposing roller of a glass ribbon conveying system, wherein a 6 o'clock position of the nip roller is aligned with a 12 o'clock position of the opposing roller.

2. The nip roller system of claim 1, further comprising an across-ribbon adjustment mechanism configured to move the nip roller in a direction perpendicular to a direction in which the glass ribbon travels while the nip roller is in contact with a traveling glass ribbon.

3. The nip roller system of claim 2, wherein
the across-ribbon adjustment mechanism is mounted to a member positioned over the glass ribbon conveying system, and
the across-ribbon adjustment mechanism comprises a liner motion control device.

4. The nip roller system of claim 3, wherein the liner motion control device comprises a slide.

5. The nip roller system of claim 1, wherein the across-ribbon adjustment mechanism comprises:
a liner motion control device; and
an extension rod comprising a first end connected to the liner motion control device and a second end connected to a handle.

6. The nip roller system of claim 1, further comprising a support structure securing the nip roller and the across-ribbon adjustment mechanism above the glass ribbon conveying system.

7. The nip roller system of claim 1, further comprising an upstream-downstream adjustment mechanism configured to move the nip roller in a direction parallel to a direction in which the glass ribbon travels.

8. The nip roller system of claim 7, wherein the upstream-downstream adjustment mechanism comprises:
a member extending across the glass ribbon conveying system and connected to the nip roller, and
a plurality of interconnecting brackets securing the member with respect to the glass ribbon conveying system.

9. The nip roller system of claim 1, further comprising an across-ribbon adjustment mechanism comprising:
a member extending across the glass ribbon conveying system and including a slot; and
a mounting plate to which the nip roller is connected, the mounting plate moveable in the slot.

10. The nip roller system of claim 1, further comprising an air cylinder assembly configured to move the nip roller in a vertical direction.

11. The nip roller system of claim 10, wherein the air cylinder assembly comprises:
an air cylinder comprising a piston that extends or retracts based on a pressure of an air source in fluid communication therewith to move the nip roller; and
a water cooled plate adjacent to the air cylinder to cool the air cylinder.

12. The nip roller system of claim 1, further comprising a nip roller assembly comprising:
a frame comprising an axle providing a rotational axis about which the nip roller rotates;
a roll pivot; and
a yaw pivot.

13. The nip roller system of claim 1, wherein the nip roller is configured to contact a central portion of the glass ribbon.

14. A glass ribbon conveying system comprising:
a drive roller configured to move the glass ribbon;
a nip roller configured to contact the glass ribbon and apply an adjustable downward force to the glass ribbon as the glass ribbon travels between the nip roller and the drive roller; and
an adjustment mechanism configured to move the nip roller in a direction lateral to which the glass ribbon travels while the nip roller is in contact with the glass ribbon.

15. The glass ribbon conveying system of claim 14, wherein the adjustable downward force is provided by an air cylinder.

16. The glass ribbon conveying system of claim 14, wherein the adjustment mechanism comprises:
a liner motion control device; and
an extension rod comprising a first end connected to the liner motion control device and a second end connected to a member configured to rotate the extension rod.

17. A method of conveying a glass ribbon, the method comprising:
driving the glass ribbon with a drive roller; and
applying an adjustable downward force to the glass ribbon by a nip roller as the glass ribbon travels between the drive roller and the nip roller, wherein a 6 o'clock position of the nip roller is aligned with a 12 o'clock position of the drive roller.

18. The method of claim 17, further comprising adjusting a position of the nip roller in a direction perpendicular to that in which the glass ribbon travels while the nip roller is in contact with the glass ribbon.

19. The method of claim 17, further comprising adjusting the downward force by changing an air pressure supplied to an air cylinder that comprises a piston that extends or retracts based on the air pressure to move the nip roller.

20. The method of claim 18, wherein the adjusting the position of the nip roller is performed by rotating an extension rod of a liner motion control device connected to the nip roller.
